(19) United States
(12) Patent Application Publication
(10) Pub. No.: US 2007/0166466 A1
(43) Pub. Date: Jul. 19, 2007

(54) Water-based heat-resistant coating composition and process for applicant thereof

(75) Inventors: Seiji Kashiwada, Kanagawa (JP); Hidekazu Kutsuma, Kanagawa (JP); Yugen Kawamoto, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KANSAI PAINT CO., LTD., Amagasaki-shi (JP)

(21) Appl. No.: 10/590,056

(22) PCT Filed: Feb. 23, 2005
(86) PCT No.: PCT/JP05/02875

§ 371 Date: Aug. 21, 2006

(30) Foreign Application Priority Data
Feb. 23, 2004 (JP) 2004-045569
Feb. 23, 2004 (JP) 2004-045762
Feb. 23, 2004 (JP) 2004-046258

(51) Int. Cl. B05D 3/02; B05D 7/00; H05B 6/02; C08K 3/22

(52) U.S. Cl. 427/372.2; 427/409; 427/543; 524/413; 524/414

(57) ABSTRACT

The present invention provides an aqueous heat-resistant coating composition comprising: (A) an aqueous carboxy-containing acrylic-modified epoxy resin dispersion obtained by neutralizing a carboxy-containing acrylic-modified epoxy resin with a basic compound and dispersing the neutralized resin in an aqueous medium; (B) an inorganic coloring pigment; and (C) a rust-preventive pigment. The present invention further provides a process for applying the same.

### TECHNICAL FIELD

The present invention relates to an aqueous heat-resistant coating composition and a process for applying the same.

### BACKGROUND ART

Various engine housing components, disc brake components, and metal automobile parts such as mufflers are exposed to high temperatures. For example, the temperature of disc rotors used as disc brake components increases to about 400° C. upon sudden breaking during high speed driving.

Metal automobile parts like those mentioned above are usually coated with a heat-resistant coating composition to enhance corrosion resistance and appearance. In recent years, in the field of heat-resistant coating compositions, a shift from organic solvent coating compositions to aqueous coating compositions has been desired to solve problems such as environmental pollution and working environment deterioration. Furthermore, a low-temperature short-time process for heat-drying a coating film is desired for space savings, energy savings, work efficiency improvements, etc. during coating.

Japanese Unexamined Patent Publication No. 1995-26166 discloses an aqueous heat-resistant coating composition comprising water glass and silicon dioxide. However, this coating composition has a problem that heat-drying takes a long time. This is because if this coating composition is heat-dried immediately after application to a metal substrate, blistering occurs in the coating film due to bump boiling of water in the coating film, and therefore, it is necessary to dry the coating film at room temperature to remove the water therefrom and then heat-dry at a high temperature. There is also another problem that when the coating composition is applied to an untreated steel plate that has not been subjected to a chemical conversion treatment, the coating film has poor corrosion resistance.

Japanese Unexamined Patent Publication No. 2002-284993 discloses an aqueous heat-resistant coating composition comprising a polyamideimide resin. However, this composition needs to be heated to a high temperature of about 400° C. for curing after application to a metal substrate, so that there is a problem that a large amount of thermal energy is required.

Japanese Unexamined Patent Publication No. 1995-247434 discloses an aqueous heat-resistant coating composition comprising a water-dispersible silicone resin. However, after application to a metal substrate, this coating composition needs to be dried at room temperature and then cured by heating at about 250° C. Therefore, particularly when the composition is applied to a thick, high-heat-capacity metal substrate, there arises a problem that a large amount of thermal energy is required. There is also another problem that when the composition is applied to a untreated steel or like plate that has not been subjected to a chemical conversion treatment, the coating film has poor corrosion resistance.

### DISCLOSURE OF INVENTION

### Problems to be Solved by the Invention

An object of the present invention is to provide an aqueous heat-resistant coating composition capable of forming a cured coating film having excellent coating properties such as heat resistance, coating hardness, adhesion, and corrosion resistance, and enabling the step of heat-drying the coating film to be performed at lower temperatures in shorter times; and a process for applying the same.

Other objects and features of the invention will become apparent from the following description.

### Means for Solving the Problems

The present inventors carried out extensive research to overcome the prior art problems and found that an aqueous coating composition comprising an aqueous dispersion of a carboxy-containing acrylic-modified epoxy resin as a resin component has excellent drying properties and is capable of forming a coating film with excellent adhesion, etc., at lower temperatures in shorter time than conventional compositions, even on thick, high-heat-capacity metal substrates. The inventors further found that when the composition further contains an inorganic coloring pigment and a rust-preventive pigment, the composition is capable of forming a coating film with excellent corrosion resistance and appearance on a steel, cast iron or like metal substrate that has not been subjected to a chemical conversion treatment, and found that the resulting coating film has a heat resistance such that the coating film can sufficiently withstand a heat of at least 400° C.

The present invention has been accomplished based on the above findings.

The present invention provides the following aqueous heat-resistant coating compositions and application processes therefor.

1. An aqueous heat-resistant coating composition comprising:

(A) an aqueous carboxy-containing acrylic-modified epoxy resin dispersion obtained by neutralizing a carboxy-containing acrylic-modified epoxy resin with a basic compound and dispersing the neutralized resin in an aqueous medium;

(B) an inorganic coloring pigment; and

(C) a rust-preventive pigment.

2. The aqueous heat-resistant coating composition according to item 1 wherein the carboxy-containing acrylic-modified epoxy resin is obtained by esterifying (a) a bisphenol epoxy resin and (b) a carboxy-containing acrylic resin.

3. The aqueous heat-resistant coating composition according to item 1 wherein the carboxy-containing acrylic-modified epoxy resin is obtained by graft polymerizing onto (a) a bisphenol epoxy resin a monomer mixture comprising a carboxy-containing polymerizable unsaturated monomer.

4. The aqueous heat-resistant coating composition according to item 1 wherein the inorganic coloring pigment (B) is manganese dioxide.

5. The aqueous heat-resistant coating composition according to item 1 wherein the rust-preventive pigment (C) is an aluminum dihydrogen tripolyphosphate rust-preventive pigment.

6. The aqueous heat-resistant coating composition according to item 5 wherein the aluminum dihydrogen tripolyphosphate rust-preventive pigment has been surface-treated with magnesium oxide or zinc oxide.

7. The aqueous heat-resistant coating composition according to item 1 wherein the total amount of inorganic coloring pigment (B) and rust-preventive pigment (C) is 5 to 100 parts by weight per 100 parts by weight of aqueous carboxy-containing acrylic-modified epoxy resin dispersion (A), on a solids basis.

8. The aqueous heat-resistant coating composition according to item 1 which further comprises (D) a resol phenolic resin.

9. The aqueous heat-resistant coating composition according to item 8 wherein the resol phenolic resin (D) has a number average molecular weight of 200 to 2,000 and an average of 0.3 to 4.0 methylol groups per benzene nucleus.

10. The aqueous heat-resistant coating composition according to item 8 wherein the amount of resol phenolic resin (D) is 0.1 to 30 parts by weight per 100 parts by weight of aqueous carboxy-containing acrylic-modified epoxy resin dispersion (A), on a solids basis.

11. An application process comprising applying the aqueous heat-resistant coating composition of item 1 to a metal substrate and then heat-drying to form a heat-resistant dried coating film.

12. The process according to item 11 wherein the heat-drying is performed by electromagnetic induction heating.

13. The process according to item 11 wherein the metal substrate is a disc break part.

14. An application process comprising heating a metal substrate by electromagnetic induction and then applying the aqueous heat-resistant coating composition of item 1 to the substrate, followed by allowing the residual heat to dry the composition to form a heat-resistant dried coating film.

15. The process according to item 14 wherein the metal substrate is a disc break part.

16. A coated article comprising a heat-resistant dried coating film formed on a metal substrate by the process of item 11.

17. The coated article according to item 16 wherein the metal substrate is a disc break part.

18. A coated article comprising a heat-resistant dried coating film formed on a metal substrate by the process of item 14.

19. The coated article according to item 18 wherein the metal substrate is a disc break part.

Aqueous Heat-Resistant Coating Composition

The aqueous heat-resistant coating composition of the invention comprises (A) an aqueous dispersion of a carboxy-containing acrylic-modified epoxy resin, (B) an inorganic coloring pigment, and (C) a rust-preventive pigment.

Aqueous Carboxy-Containing Acrylic-Modified Epoxy Resin Dispersion (A)

The aqueous dispersion used as component (A) is obtained by neutralizing a carboxy-containing acrylic-modified epoxy resin with a basic compound and dispersing the neutralized resin in an aqueous medium.

Examples of resins preferably used as the carboxy-containing acrylic-modified epoxy resin include resins (I) obtained by esterifying a bisphenol epoxy resin (a) and a carboxy-containing acrylic resin (b); resins (II) obtained by graft polymerizing onto a bisphenol epoxy resin (a) a monomer mixture comprising a carboxy-containing polymerizable unsaturated monomer; and the like.

When producing resins (I), the esterification reaction can be easily carried out by heating the epoxy resin (a) and acrylic resin (b) in an organic solvent solution in the presence of an esterification catalyst.

When producing resins (II), such resins can be synthesized, for example, by graft polymerizing the carboxy-containing polymerizable unsaturated monomer mixture onto the epoxy resin (a) in an organic solvent in the presence of a radical polymerization initiator.

Examples of bisphenol epoxy resin (a) include resins (i) obtained by subjecting epichlorohydrin and bisphenol to condensation, optionally in the presence of a catalyst such as an alkali catalyst, to give a number average molecular weight of about 5,000 or more; and resins (ii) obtained by subjecting epichlorohydrin and bisphenol to condensation, optionally in the presence of a catalyst such as an alkali catalyst, to provide a low molecular weight epoxy resin with a number average molecular weight of about 300 to about 1,500 and then subjecting the low molecular weight epoxy resin and a bisphenol to a polyaddition reaction; epoxy ester resins obtained by reacting resin (i) or (ii) or the above low molecular weight epoxy resin with a dibasic acid; and the like.

Examples of bisphenols include bis(4-hydroxyphenyl)methane [commonly called “bisphenol F”], 1,1-bis(4-hydroxyphenyl)ethane, 2,2-bis(4-hydroxyphenyl)propane [commonly called “bisphenol A”], 2,2-bis(4-hydroxyphenyl)butane [commonly called “bisphenol B”], bis(4-hydroxyphenyl)-1,1-isobutane, bis(4-hydroxy-tert-butyl-phenyl)-2,2-propane, p-(4-hydroxyphenyl)phenol, oxybis(4-hydroxyphenyl), sulfonylbis(4-hydroxyphenyl), 4,4′-dihydroxybenzophenone, bis(2-hydroxynaphthyl)methane and the like. Among these, bisphenol A, and bisphenol F are preferable. Such bisphenols can be used singly or as a mixture of two or more such bisphenols.

Examples of dibasic acids preferably used to produce the epoxy ester resin include compounds represented by the formula HOOC—(CH₂)ₙ—COOH (wherein n is an integer from 1 to 12). Specific examples thereof include succinic acid, adipic acid, pimelic acid, azelaic acid, sebacic acid, dodecanedioic acid, and the like.

Examples of resins usable as bisphenol epoxy resin (a) include commercially available products. Examples of such commercially available products include “EPIKOTE 1007” (trade name, epoxy equivalent: about 1,700, number average molecular weight: about 2,900), “EPIKOTE 1009” (trade name, epoxy equivalent: about 3,500, number average molecular weight: about 3,800), and “EPIKOTE 1010” (trade name, epoxy equivalent: about 4,500, number average molecular weight: about 5,500), all the above products being manufactured by Japan Epoxy Resin Co., Ltd.; “Araldite AER6099” (trade name, epoxy equivalent: about 3,500, number average molecular weight: about 3,800) manufactured by Ciba Geigy, and “Epomix R-309” (trade name, epoxy equivalent: about 3,500, number average molecular weight: about 3,800) manufactured by Mitsui Petrochemical Industries, Ltd.

To enhance hardness, corrosion resistance, etc. of the resulting coating film, the bisphenol epoxy resin (a) preferably has a number average molecular weight of about 2,000 to about 35,000 and an epoxy equivalent of about 1,000 to about 12,000, and more preferably a number molecular weight of 4,000 to 30,000 and an epoxy equivalent of 3,000 to 10,000.

The carboxy-containing acrylic resin (b) is obtained by copolymerizing a monomer mixture comprising a carboxy-containing polymerizable unsaturated monomer and other polymerizable unsaturated monomer(s).

Examples of carboxy-containing polymerizable unsaturated monomers include acrylic acid, methacrylic acid, crotonic acid, itaconic acid, maleic acid, fumaric acid and the like. Methacrylic acid is particularly preferable. Such monomers can be used singly or as a mixture of two or more such monomers.

Examples of other polymerizable unsaturated monomers include any monomers that can be copolymerized with the carboxy-containing polymerizable unsaturated monomer and can be suitably selected according to the desired properties. Specific examples thereof include styrene, vinyltoluene, 2-methylstyrene, t-butylstyrene, chlorostyrene and like aromatic vinyl monomers; methyl acrylate, ethyl acrylate, n-propyl acrylate, isopropyl acrylate, n-butyl acrylate, isobutyl acrylate, t-butyl acrylate, hexyl acrylate, 2-ethylhexyl acrylate, n-octyl acrylate, decyl acrylate, lauryl acrylate, cyclohexyl acrylate, methyl methacrylate, ethyl methacrylate, n-propyl methacrylate, isopropyl methacrylate, n-butyl methacrylate, isobutyl methacrylate, t-butyl methacrylate, hexyl methacrylate, 2-ethylhexyl methacrylate, octyl metharylate, decyl methacrylate, lauryl methacylate, cyclohexyl methacrylate and like C₁₋₁₈ alkyl esters or cycloalkyl esters of acrylic acid/methacrylic acid; 2-hydroxyethyl acrylate, 2-hydroxypropyl acrylate, 3-hydroxypropyl acrylate, hydroxybutyl acrylate, 2-hydroxyethyl methacrylate, 2-hydroxypropyl methacrylate, 3-hydroxypropyl methacrylate, hydroxybutyl methacrylate and like C₂₋₈ hydroxyalkyl esters of acrylic acid/methacrylic acid; N-methylolacrylamide, N-buthoxymethylacrylamide, N-methoxymethylacrylamide, N-methylolmethacrylamide, N-buthoxymethyl methacrylamide, and like N-substituted acrylamide or N-substituted methacrylamide monomers. Such other polymerizable monomers can be used singly or as a mixture of two or more monomers.

A mixture of styrene and ethyl acrylate is particularly preferable as such other polymerizable unsaturated monomer(s). The styrene/ethyl acrylate weight ratio (%) in the mixture is preferably within the range of from about 99.9/0.1 to about 40/60, and more preferably about 99/1 to about 50/50.

The proportions of the starting monomers for the acrylic resin (b) are not particularly limited. It is usually preferable that the carboxy-containing polymerizable unsaturated monomer be about 15 to 60 wt. % and that of other polymerizable unsaturated monomer(s) be about 85 to 40 wt. %. It is more preferable that the proportion of carboxy-containing polymerizable unsaturated monomer be about 20 to 50 wt. %, and that of other polymerizable unsaturated monomer(s) be about 80 to 50 wt. %.

The acrylic resin (b) can be easily prepared, for example, by dissolving and polymerizing such a carboxy-containing polymerizable unsaturated monomer and other polymerizable unsaturated monomer(s) in an organic solvent in the presence of a radical polymerization initiator.

The acrylic resin (b) preferably has an acid value of about 100 to about 400 mg KOH/g, and a number average molecular weight of about 5,000 to about 100,000.

In the esterification reaction for producing resins (I), the proportions of epoxy resin (a) and acrylic resin (b) can be suitably selected according to the coating workability and coating film properties, within the range that carboxyl group equivalents are present in excess relative to epoxy group equivalents. It is usually preferable that the weight ratio of epoxy resin (a): acrylic resin (b) be in the range of from 6:4 to 9:1, and more preferably 7:3 to 9:1.

The esterification reaction can be carried out by a known method, for example, by adding an esterification catalyst to a homogenous organic solvent solution of epoxy resin (a) and acrylic resin (b) and allowing the reaction to proceed at a temperature of about 60 to about 130° C. for about 1 to about 6 hours until substantially all the epoxy groups have been consumed.

Examples of usable esterification catalysts include tertiary amines such as triethylamine, dimethylethanolamine, and the like; quaternary salt compounds such as triphenylphosphine and the like. Among these, tertiary amines are preferable.

The solids concentration of epoxy resin (a) and acrylic resin (b) in the reaction system is not particularly limited as long as the reaction system has a viscosity that does not impede the reaction. When an esterification catalyst is used for the esterification reaction, the catalyst is preferably used in an amount of about 0.1 to about 1 equivalent per epoxy equivalent of epoxy resin (a).

When the above-mentioned resin (II) is used as the carboxy-containing acrylic-modified epoxy resin (A), the monomer mixture comprising a carboxy-containing polymerizable unsaturated monomer to be graft polymerized onto epoxy resin (a) may be the same as the monomer mixture used to produce acrylic resin (b), the mixture comprising a carboxy-containing polymerizable unsaturated monomer and other polymerizable unsaturated monomer(s).

In the production of resins (II), the proportions of epoxy resin (a) and monomer mixture comprising a carboxy-containing unsaturated monomer are not particularly limited. It is usually preferable that the former/latter weight ratio be in the range of from 95/5 to 70/30, based on the total weight of the two. In this case, the proportion of carboxy-containing unsaturated monomer in the monomer mixture is preferably about 20 to about 80 wt. %. In the graft polymerization reaction of the monomer mixture comprising a carboxy-containing polymerizable unsaturated monomer onto the epoxy resin (a), it is usually preferable that the radical polymerization initiator be used in an amount of about 3 to about 15 parts by weight per 100 parts by weight of monomer mixture.

The graft polymerization reaction can be carried out by a known method, for example by heating an organic solvent solution of epoxy resin (a) at about 80 to about 150° C., gradually adding thereto a homogenous mixed solution of the radical polymerization initiator and the monomer mixture comprising a carboxy-containing polymerizable unsaturated monomer, and maintaining the resulting mixture at the same temperature for about 1 to about 10 hours.

Examples of radical polymerization initiators usable in the production of resin (I) or (II) include azobisisobutyronitrile, benzoylperoxide, t-butylperbenzoyl octanoate, t-butylperoxy-2-ethylhexanoate, and the like.

Organic solvents used in the production of resin (I) or (II) may be any solvent that is capable of dissolving the epoxy resin (a) and acrylic resin (b) or the epoxy resin (a) and monomer mixture comprising a carboxy-containing polymerizable unsaturated monomer, and that does not impede the neutralization of the obtained carboxy-containing acrylic-modified epoxy resin to give an aqueous dispersion.

Examples of usable organic solvents include hydrophilic solvents such as alcohol solvents, cellosolve solvents, carbitol solvents, and the like. Examples of alcohol solvents include isopropanol, butyl alcohol, 2-hydroxy-4-methylpentane, 2-ethylhexyl alcohol, cyclohexanol, ethylene glycol, diethylene glycol, 1,3-butylene glycol, and the like. Examples of cellosolve solvents include ethylene glycol monoethyl ether, ethylene glycol monobutyl ether, ethylene glycol monopropyl ether, and the like. Examples of carbitol solvents include diethylene glycol monomethyl ether, diethylene glycol monoethyl ether, diethylene glycol monobutyl ether, and the like.

Further, hydrophobic organic solvents may be used together with such hydrophilic organic solvents within the range that does not adversely affect the stability of the carboxy-containing acrylic-modified epoxy resin in the aqueous medium. Examples of such hydrophobic solvents include toluene, xylene and like aromatic hydrocarbon solvents; ethyl acetate, butyl acetate and like ester solvents; and acetone, methyl ethyl ketone and like ketone solvents.

To provide excellent water dispersibility and coating performance, the carboxy-containing acrylic-modified epoxy resin preferably has an acid value of about 10 to about 160 mg KOH/g, and more preferably has an acid value of about 20 to about 100 mg KOH/g.

The carboxy-containing acrylic-modified epoxy resin becomes dispersible in an aqueous medium upon neutralization of carboxy groups in the resin with a basic compound.

The basic compound used to neutralize carboxy groups is preferably an amine or ammonia. Typical examples of amines include trimethylamine, triethylamine, tributylamine and like alkylamines; dimethylethanolamine, diethanolamine, aminomethylpropanol, and like alkanolamines; morpholine and like cyclic amines; and the like. Although the degree of neutralization of the carboxy-containing acrylic-modified epoxy resin is not particularly limited, it is usually preferable that 0.1 to 2.0 equivalents be used for neutralization per carboxyl group in the resin.

The aqueous medium may be water alone or a mixture of water and organic solvent. Examples of usable organic solvents include hydrophilic organic solvents that do not adversely affect the stability of the carboxy-containing acrylic-modified epoxy resin in the aqueous medium. Examples of such hydrophobic solvents include alcohol solvents, cellosolve solvents, carbitol solvents and like organic solvents mentioned as usable to produce the carboxy-containing acrylic-modified epoxy resin.

The carboxy-containing acrylic-modified epoxy resin can be neutralized and dispersed in the aqueous medium by known methods. Examples of usable methods include a method comprising gradually adding the acrylic-modified epoxy resin, with stirring, to an aqueous medium containing a basic compound acting as a neutralizing agent; and a method comprising neutralizing the acrylic-modified epoxy resin with a basic compound and then adding an aqueous medium to the neutralized resin with stirring or adding the neutralized resin to an aqueous medium with stirring.

Thus aqueous carboxy-containing acrylic-modified epoxy resin dispersion (A) can be obtained.

Inorganic Coloring Pigment (B)

Inorganic coloring pigment (B) in the heat-resistant coating composition of the invention is used to form a colored coating film on the metal substrate in order to improve the appearance. When the metal substrate is continuously or intermittently exposed to high temperature, the coating film to be formed is required to have heat resistance. Since organic coloring pigments have poor heat resistance, an inorganic coloring pigment with excellent heat resistance is used.

Examples of usable inorganic coloring pigments include titanium dioxide, zinc oxide, Titanium Yellow, Ultramarine Blue, Prussian Blue, carbon black, graphite, manganese dioxide, spinel pigments, iron oxide pigments, tin oxide pigments, zircon pigments, and complex oxides of various colors obtained by heat-treating two or more such pigments. Examples of usable iron oxide pigments include black iron oxide, yellow iron oxide, red iron oxide, and the like. Examples of usable complex oxides include commercially available products. Examples of such commercially available products include “DAIPYROXIDE” (trade name) manufactured by Dainichiseika Color & Chemicals Mfg. Co., Ltd. Further examples of inorganic coloring pigments include luster pigments. Examples of inorganic luster pigments include aluminum flakes, stainless steel flakes, and like metal flakes; mica, flaky iron oxide, glass flakes, pearl pigments, and the like.

One or a combination of two or more such coloring pigments can be used in the present invention.

When a black pigment is used, graphite, manganese dioxide, calcined complex iron oxide and the like are preferable because of their excellent heat resistance at high temperatures of 400° C. or more. Manganese dioxide is particularly preferable because of its excellent corrosion resistance, dispersibility, cost, etc.

Rust-Preventive Pigment (C)

Rust-preventive pigment (C) in the heat-resistant coating composition of the invention is used to impart corrosion resistance to a metal substrate.

Usable rust-preventive pigments are those not containing chromium, lead, cadmium, or like heavy metals that are harmful to the human body and the environment. Specific examples of usable rust-preventive pigments include zinc oxide; zinc phosphate, calcium phosphate, magnesium phosphate, zinc phosphomolybdate, calcium phosphomolybdate, aluminum phosphomolybdate, and like phosphate rust-preventive pigments; zinc phosphite, calcium phosphite, aluminum phosphite, strontium phosphite and like phosphite rust-preventive pigments; molybdate rust-preventive pigments; zinc cyanamide rust-preventive pigments; zinc calcium cyanamide rust-preventive pigments; aluminum dihydrogen tripolyphosphate rust-preventive pigments; rust-preventive pigments mainly consisting of amorphous silica; and the like.

To impart excellent stability to the aqueous carboxy-containing acrylic-modified epoxy resin dispersion (A) and provide the coating film with excellent corrosion resistance, aluminum dihydrogen tripolyphosphate rust-preventive pigments are preferable, and those surface-treated with magnesium oxide, calcium oxide, zinc oxide, or the like are more preferable. Examples of usable aluminum dihydrogen tripolyphosphate rust-preventive pigments include commercially available products. Examples of such commercially available products include “K-WHITE 84” and “K-WHITE 84S” having been surface-treated with silica and/or zinc oxide, “K-WHITE 105” and “K-WHITE 140W” having been surface-treated with zinc oxide, “K-WHITE G105” and “K-WHITE 450H” having been surface-treated with magnesium oxide, and “K-WHITE Ca650” having been surface-treated with calcium oxide, all the above being trade names for the products of Tayca Corporation.

One or a combination of two or more such rust-preventive pigments can be used in the present invention.

Proportions of Inorganic Coloring Pigment (B) and Rust-Preventive Pigment (C)

The proportions of inorganic coloring pigment (B) and rust-preventive pigment (C) in the aqueous heat-resistant coating composition may vary according to the coating thickness of the coating composition. However, the total amount of the two components should be such an amount that can completely hide the substrate and impart sufficient corrosion resistance to the coating film.

In view of finish, corrosion resistance, etc., the coating thickness of the composition of the invention is usually about 10 to about 50 μm, when dried. With such a coating thickness, the total amount of inorganic coloring pigment and rust-preventive pigment is preferably about 5 to about 100 parts by weight, and more preferably about 10 to about 80 parts by weight, per 100 parts by weight of aqueous carboxy-containing acrylic-modified epoxy resin dispersion (A), on a solids basis. When the total amount is less than 5 parts by weight, hiding power, corrosion resistance, etc. tend to be poor. When the total amount exceeds 100 parts by weight, an applied high-temperature thermal load of 300° C. or more, and especially 400° C. or more, tends to reduce corrosion resistance.

The proportions of inorganic coloring pigment (B) and rust-preventive pigment (C) can be suitably selected considering that hiding power is mostly due to component (B), and corrosion resistance is mainly due to component (C). It is usually preferable that the proportion of inorganic coloring pigment (B) be about 20 to about 80 wt. % and that of rust-preventive pigment (C) be about 80 to about 20 wt. %, based on the total weight of these two components.

Resol Phenolic Resin (D)

When the coating composition of the invention further contains a resol phenolic resin (D), adhesion to metal substrates and corrosion resistance can be further enhanced. The resol phenolic resin (D) acts as a cross-linking agent for the carboxy-containing acrylic-modified epoxy resin.

Examples of resol phenolic resins include methylolated phenolic resins obtained by condensation reaction of a phenol and an aldehyde in the presence of a reaction catalyst; compounds obtained by alkyletherifying some of the methylol groups of such a methylolated phenolic resin; and the like.

Examples of phenols usable to produce the resol phenolic resin include o-cresol, p-cresol, p-tert-butylphenol, p-ethylphenol, 2,3-xylenol, 2,5-xylenol, and like bifunctional phenols; phenol, m-cresol, m-ethylphenol, 3,5-xylenol, m-methoxyphenol and like trifunctional phenols; bisphenol A, bisphenol F and like tetrafunctional phenols; and the like. Such phenols may be used singly or as a mixture of two or more such phenols.

Examples of aldehydes usable to produce the resol phenolic resin include formaldehyde, paraformaldehyde, trioxane, and the like. Such aldehydes may be used singly or as a mixture of two or more such aldehydes.

Preferable examples of alcohols usable for alkyletherifying some of the methylol groups of a methylolated phenolic resin include monovalent alcohols having 1 to 8 carbon atoms, and more preferably monovalent alcohols having 1 to 4 carbon atoms. Specific examples thereof include methanol, ethanol, n-butanol, isobutanol, and the like. Among these, methanol is particularly preferable.

The resol phenolic resin (D) preferably has a number average molecular weight of about 200 to about 2,000 and an average of about 0.3 to about 4.0 methylol groups per benzene nucleus, and more preferably has a number average molecular weight of about 300 to about 1,200 and an average of about 0.5 to about 3.0 methylol groups per benzene nucleus.

Examples of resol phenolic resins include commercially available products. Examples of such commercially available products include “Shonol BKS-377F”, “Shonol CKS-3865”, and “Shonol CKS-3873F”, which are trade names of products manufactured by Showa Highpolymer Co., Ltd.

In the coating composition of the invention, the proportion of resol phenolic resin (D) is preferably about 0.1 to about 30 parts by weight, and more preferably about 0.5 to about 20 parts by weight, per 100 parts by weight of aqueous carboxy-containing acrylic-modified epoxy resin dispersion (A), on a solids basis. When the amount of resol-type phenolic resin (D) is less than 0.5 parts by weight, enhancement of adhesion, corrosion resistance, and like properties may be insufficient. When the amount of resol phenolic resin (D) exceeds 30 parts by weight, low impact resistance may result.

Preparation of Coating Composition

The coating composition of the invention can be prepared by dissolving or dispersing the above components (A) to (D), and if required, optional component(s), in an aqueous medium such as water or a mixture of water and organic solvent to adjust the solids concentration to about 20 to about 60 wt. %. In this process, it is preferable that the coloring pigment (B) and the rust-preventive pigment (C) be formed into paste(s) using various dispersing agents and then mixed. As regards usable aqueous media, the aqueous medium used to prepare each component may be used as is, or a suitable amount of aqueous medium may be added.

Extender pigments and fibrous pigments may be used as optional components in the coating composition of the invention. Examples of extender pigments include silica, alumina, mica, clay, talc, barium sulfate, calcium carbonate, and the like. Examples of fibrous pigments include glass fibers, alumina fibers, boron fibers, potassium titanate whiskers, silicon nitride whiskers, xonotlite, and the like. Examples of other usable optional components include dispersants, thickeners, defoaming agents, leveling agents, antifoaming agents, UV absorbers, light stabilizers, and the like.

Using water and organic solvent in combination as the aqueous medium can prevent blistering caused by evaporation of the aqueous medium when drying the coating film. Organic solvents preferably used with water are hydrophilic organic solvents. Examples of such hydrophilic organic solvents include ethylene glycol, ethylene glycol monoisopropyl ether, ethylene glycol monobutyl ether, ethylene glycol mono-t-butyl ether, ethylene glycol monomethyl ether acetate, and like ethylene glycol derivatives; propylene glycol monomethyl ether, propylene glycol monomethyl ether propionate, and like propylene glycol derivatives; hexylene glycol, diethylene glycol monobutyl ether, and like diethylene glycol derivatives; diacetone alcohol; and the like. Such hydrophilic organic solvents may be used singly or as a mixture of two or more such solvents.

Process of Applying the Aqueous Heat-Resistant Coating Composition

The application process of the invention comprises applying the aqueous heat-resistant coating composition of the invention to a metal substrate and then drying by heating to form a heat-resistant dried coating film.

The metal substrate to which the composition is applied is not particularly limited, and examples thereof include various metal parts exposed to high temperature. Specific examples include various engine housing components; disc break components such as disc rotors and drum-in-discs; various metal automobile parts such as mufflers; and the like. Such metal parts are made of various metals such as steel, cast iron, aluminum, and the like. Their shapes may vary according to the kind of part, and are not limited.

Although the surface of the metal substrate may have been subjected to a chemical conversion treatment with zinc phosphate, iron phosphate, or the like, such a chemical conversion is unnecessary because the coating composition of the invention can form a coating film with sufficient corrosion resistance even on an untreated metal substrate which has not been subjected to a chemical conversion.

It is usually preferable that, at the time of application, the coating composition of the invention has a viscosity of about 10 to about 50 seconds as measured by Ford Cup No. 4. The coating composition of the invention can be applied to a metal substrate by a known application process, such as air spray coating, airless spray coating, dip coating, shower coating, roll coater coating, curtain flow coating, or the like. The coating composition is preferably applied to a thickness of about 10 to about 50 μm, and more preferably about 20 to about 30 μm, when dried.

To provide excellent adhesion, corrosion resistance, etc., the coating composition of the invention is usually dried at 120° C. or more, and preferably about 140° C. to about 200° C., after application to a metal substrate, thereby giving a dried coating film or a cured coating film. Usually, the drying time is preferably about 2 to about 30 minutes, and more preferably about 3 to about 30 minutes.

Usable drying devices are not particularly limited, as long as the above-mentioned drying conditions can be provided. More specifically, for example, hot air circulating dryers, infrared radiation heaters, electromagnetic induction heaters, and the like can be used.

Among the above drying devices, when using an electromagnetic induction heaters to dry the coating composition applied to a thick, high-heat-capacity metal substrate, for example, a disc break component such as a disc rotor of thick plates, the drying time after application can be greatly reduced. When using electromagnetic induction heating, the substrate to which the coating composition is applied needs to be a magnetic material. Metal substrates meet this requirement.

FIG. 1 shows a schematic view of one embodiment of an electromagnetic induction heater. Reference numeral 1 indicates a magnetic field generation coil, 2 a plate, 3 a magnetic line of force, 4 an eddy current, and 5 a metal substrate. When using such a device, the metal substrate 5 is placed on a plate 2 made of crystalline glass, etc., and magnetic lines of force are generated by the magnetic field generation coil 1 disposed below the plate 2, and eddy currents are generated in the metal substrate 5, thereby heating the substrate.

For example, when a flat cast iron plate substrate with a thickness of about 10 mm is heated by electromagnetic induction, the temperature of the substrate can be raised to about 170 to about 220° C. for about 2 to about 5 minutes by controlling the current passing through the magnetic field generation coil 1. Thus, after application of the coating composition of the invention to the substrate, electromagnetic induction heating enables the process of drying the coating film to be completed in an extremely short time, e.g., in about 2 to about 5 minutes. When dried, if the coating film of the coating composition of the invention contains component (D), the film is cured by crosslinking.

The heat-resistant dried coating film can also be obtained by heating a metal substrate by electromagnetic induction and thereafter applying the coating composition of the invention to the substrate and drying by the residual heat. In this case, when the metal substrate is heated to, for example, about 160 to about 200° C. by electromagnetic induction heating and thereafter the coating composition is applied, residual heat can completely dry the coating film in an extremely short time, e.g., in about 1 to about 5 minutes.

After the coating film on the metal substrate has been dried, for example, by electromagnetic induction heating, quenching to a temperature at which the coated substrate can be handled for subsequent processing (e.g., 60° C. or less) can enhance work efficiency.

Examples of usable quenching methods include known methods such as methods of showering or immersion in water at room temperature to about 10° C., gas blowing methods using air, nitrogen gas, etc., and the like. Methods comprising showering tap water and/or industrial water are industrially preferable in terms of economy, facilities, cooling efficiency, etc.

Showering time and the amount of showering water are not particularly limited as long as the temperature of the entire surface of the coated substrate can be reduced to a temperature at which the coated substrate is not difficult to handle. For example, when the coating film is quenched after being dried and allowed to cool to a temperature of about 160 to about 180° C., a plurality of shower nozzles can be provided to shower the entire surface of the coated substrate using room temperature water for 30 seconds, while controlling the amount of showering water, thereby lowering the temperature to 60° C. or less and enabling the coated substrate to be handled.

Thus a coated article comprising a heat-resistant dried coating film formed on a metal substrate such as a disc break component can be obtained by the application process of the invention.

### EFFECTS OF THE INVENTION

The present invention achieves the following remarkable effects:

(1) Since the coating composition of the present invention comprises an aqueous carboxy-containing acrylic modified epoxy resin dispersion as a resin component, the composition provides a coating film with excellent drying properties and is capable of forming a coating film with excellent adhesion, etc. at lower temperatures in shorter times than conventional compositions, even on thick, high-heat-capacity metal substrates.

(2) Since the coating composition of the invention comprises an inorganic coloring pigment and a rust-preventive pigment, the coating composition is capable of forming a coating film with excellent corrosion resistance, appearance and heat resistance such that the coating film can sufficiently withstand a heat of at least 400° C. on an untreated metal substrate that has not been subjected to a chemical conversion treatment.

(3) Since the coating composition of the invention is water-based, problems such as environmental pollution and working environment deterioration can be obviated.

(4) Since the process for application of the invention comprises a low-temperature short-time heat-drying step, space savings, energy savings and work efficiency improvements, etc. can be easily achieved.

### BRIEF DESCRIPTION OF THE DRAWINGS

FIG. 1 shows a schematic view of one embodiment of an electromagnetic induction heater.

FIG. 2 is a graph of substrate temperature with time during the preparation of the coated test plate of Example 5.

FIG. 3 is a graph of substrate temperature with time during the preparation of the coated test plate of Example 7.

### DESCRIPTION OF REFERENCE NUMERALS

1: magnetic field generation coil,
2: plate,
3: magnetic line of force,
4: eddy current,
5: metal substrate.

### BEST MODE FOR CARRYING OUT THE INVENTION

The following Production Examples, Examples and Comparative Examples are provided to illustrate the present invention in further detail. However, the present invention is not limited thereto. In the examples, parts and percentages are by weight, and the thickness of coating films is coating thickness, when dried.

### Production Example 1 Production of Bisphenol Epoxy Resin

A 4-necked flask equipped with a reflux condenser, thermometer, and stirrer was charged with 558 parts of a low molecular weight bisphenol A epoxy resin (trade name “Epikote 828EL”, product of Japan Epoxy Resin Co., Ltd., having an epoxy equivalent of about 190 and a number average molecular weight of about 350), 329 parts of bisphenol A, and 0.6 parts of tetrabutylammonium bromide, and the reaction was allowed to proceed at 160° C. under a nitrogen stream. The reaction was monitored by determination of epoxy equivalent, and the reaction was allowed to proceed for about 5 hours to give a bisphenol A epoxy resin (a-1) with a number average molecular weight of about 11,000, and an epoxy equivalent of about 8,000.

### Production Example 2 Production of Carboxy-Containing Acrylic Resin Solution

Eight hundred eighty-two parts of n-butanol was placed into a 4-necked flask equipped with a reflux condenser, thermometer, and stirrer, and heated to 100° C. under a nitrogen stream. While the temperature was maintained, a mixture of 180 parts of methacrylic acid, 240 parts of styrene, 180 parts of ethyl acrylate, and 18 parts of t-butylperoxy-2-ethylhexanoate was added dropwise through a dropping funnel over about 3 hours. After the dropwise addition, stirring was continued for 2 hours at the same temperature, followed by cooling, thus giving a carboxy-containing acrylic resin (b-1) with a solids content of about 40%. The resin (b-1) had an acid value of 196 mg KOH/g and a number average molecular weight of about 19,000.

### Production Example 3 Production of Aqueous Dispersion of Carboxy-Containing Acrylic-Modified Epoxy Resin

Eighty parts of the bisphenol A epoxin resin (a-1) obtained in Production Example 1, 50 parts (20 parts on a solids basis) of the 40% carboxy-containing acrylic resin (b-1) obtained in Production Example 2, and 33 parts of diethylene glycol monobutyl ether were placed in a 4-necked flask equipped with a reflux condenser, thermometer, and stirrer, and heated to 100° C. to obtain a solution, followed by addition of 5 parts of N,N-dimethylaminoethanol. The reaction was allowed to proceed at the same temperature for 2 hours to produce a carboxy-containing acrylic-modified epoxy resin solution. The obtained resin had an acid value of 34 mg KOH/g. Subsequently, the temperature of this resin solution was raised to 70° C., and 224 parts of deionized water was gradually added to give an aqueous dispersion. Excess solvent was distilled off under reduced pressure to give an aqueous carboxy-containing acrylic-modified epoxy resin dispersion (A-1) with a solids content of 32%.

### Production Example 4 Production of Aqueous Dispersion of Carboxy-Containing Acrylic-Modified Epoxy Resin Dispersion

Eighty parts of the bisphenol A epoxin resin (a-1) obtained in Production Example 1, 28 parts of n-butanol, and 33 parts of diethylene glycol monobutyl ether were placed in a 4-necked flask equipped with a reflux condenser, thermometer, and stirrer, and heated to 115° C. to obtain a solution. A mixture of 6 parts of methacrylic acid, 8 parts of styrene, 6 parts of ethyl acrlyate, and 2 parts of benzoyl peroxide was added dropwise through a dropping funnel over about 1 hour, and the reaction was allowed to proceed at the same temperature for about 2 hours. After cooling to 105° C., 5 parts of N,N-dimethylaminoethanol was added and the resulting mixture was stirred for 5 minutes to give a carboxy-containing acrylic-modified epoxy resin solution. The obtained resin had an acid value of 34 mg KOH/g. Subsequently, the temperature of the solution was reduced to 70° C., and 224 parts of deionized water was gradually added to give an aqueous dispersion. Excess solvent was distilled off under reduced pressure to give an aqueous carboxy-containing acrylic-modified epoxy resin dispersion (A-2) with a solids content of 32%.

### Production Example 5 Production of Resol Phenolic Resin Solution

One hundred eighty-eight parts of phenol and 324 parts of a 37% aqueous formaldehyde solution were placed in a 4-necked flask equipped with a reflux condenser, thermometer, and stirrer, and heated to 50° C. to uniformly dissolve the contents. Zinc acetate was added to the solution and mixed to adjust the pH of the reaction system to 5.0. The resulting mixture was heated to 90° C. and the reaction was allowed to proceed for 5 hours. After the reaction mixture was cooled to 50° C., a 32% aqueous calcium hydroxide dispersion was slowly added to adjust the pH to 8.5, and the reaction was allowed to proceed at 50° C. for 4 hours. After completion of the reaction, 20% hydrochloric acid was added to adjust the pH to 4.5, and the resin components were extracted with a mixed solvent of xylene/n-butanol/cyclohexane=1/2/1 (by weight). After removing the catalyst (zinc acetate) and neutralized salt (calcium chloride), the extract was subjected to azeotropic dehydration under reduced pressure to give a pale yellow transparent resol phenolic resin solution with a nonvolatile content of 60%. The obtained resol phenoic resin had a number average molecular weight of 1,100 and an average of 1.0 methylol group per benzene nucleus.

### Example 1 Production of Aqueous Heat-Resistant Coating Composition

Ten parts of electrolytic manganese dioxide, 15 parts of an aluminum dihydrogen tripolyphosphate rust-preventive pigment surface-treated with magnesium oxide (trade name “K-WHITE 450H”, product of Tayca Corporation), and 20 parts of alumina powder (trade name “AM-21”, product of Sumitomo Chemical Co., Ltd., extender pigment) were added to a mixture of 28.5 parts of ethylene glycol monobutyl ether and 1.5 parts of a dispersant (trade name “Disperbyk-180”, product of BYK-Chemie, an alkylammonium salt of an acid group-containing block copolymer), and stirred well. The resulting mixture was dispersed using a sand mill to a particle size of not more than 20 μm, thus giving a dispersion paste (i) with a pigment content of 60%.

Seventy-five parts (45 parts on a solids basis) of the 60% pigment dispersion paste (i) was added to 312.5 parts (100 parts on a solids basis) of the 32% aqueous carboxy-containing acrylic-modified epoxy resin dispersion (A-1) obtained in Production Example 3, and stirred well to give a black aqueous heat-resistant coating composition with a solids content of 37.4%.

### Example 2 Production of Aqueous Heat-Resistant Coating Composition

Seventy-five parts (45 parts on a solids basis) of the 60% pigment dispersion paste (i) obtained in Example 1 was added to 312.5 parts (100 parts on a solids basis) of the 32% aqueous carboxy-containing acrylic-modified epoxy resin dispersion (A-2) obtained in Production Example 4, and stirred well to give a black aqueous heat-resistant coating composition with a solids content of 37.4%.

### Example 3 Production of Aqueous Heat-Resistant Coating Composition

The 60% resol phenolic resin obtained in Production Example 5 (8.33 parts, i.e., 5 parts on a solids basis) was added to 296.9 parts (95 parts on a solids basis) of the 32% carboxy-containing acrylic modified epoxy resin dispersion (A-1) obtained in Production Example 3, followed by addition of 75 parts (45 parts on a solids basis) of the 60% pigment dispersion paste (i) obtained in Example 1. The resulting mixture was stirred well to give a black aqueous heat-resistant coating composition with a solids content of 38.1%.

### Example 4 Production of Aqueous Heat-Resistant Coating Composition

Fifteen parts of a calcium phosphate/magnesium phosphate rust-preventive pigment (product name: “LF BOUSEI CPM”, product of Kikuchi Color & Chemicals Corporation) and 15 parts of alumina powder (trade name “AM-21”) were added to a mixture of 19 parts of ethylene glycol monobutyl ether and 1 part of a dispersant (trade name “Disperbyk-180”). The resulting mixture was stirred well and dispersed using a sand mill to a particle size of 20 μm or less, thus giving a pigment dispersion paste (ii) with a pigment content of 60%, that was free of coloring pigments.

Subsequently, 30.3 parts of a 66% aluminum powder paste (trade name “Alpaste 50-635”, using mineral spirits as a medium, product of Toyo Aluminium K.K.) was added to 15.4 parts of ethylene glycol monobutyl ether, and the resulting mixture was stirred well. Subsequently, 10 parts of a phosphoric acid group-containing acrylic resin (an aluminum powder inactivator, trade name “50% KZX937”, product of Kansai Paint Co., Ltd.) and 0.8 parts of dimethyl ethanol amine were added to give an aluminum powder dispersion paste with a solids content of 35.4%.

The 60% resol phenolic resin solution obtained in Production Example 5 (16.67 parts, i.e., 10 parts on a solids basis) was added to 281.3 parts (90 parts on a solids basis) of the 32% aqueous carboxy-containing acrylic-modified epoxy resin dispersion (A-2) obtained in Production Example 4, followed by addition of 50 parts of the 60% pigment dispersion paste (ii) and 84.8 parts (30 parts on an aluminum solids basis) of the aluminum powder paste. The resulting mixture was stirred well to give a silver aqueous heat-resistant coating composition with a solids content of 38.7%.

### Comparative Example 1 Production of Aqueous Heat-Resistant Coating Composition

Ten parts of graphite was added to a mixture of 17.9 parts of ethylene glycol monobutyl ether and 1.5 parts of a dispersant (trade name “Disperbyk-180”). The resulting mixture was stirred well and dispersed using a sand mill to a particle size of 20 μm or less, thus giving an approximately 34% pigment dispersion paste (iii), not containing a rust-preventive pigment.

The 34% pigment dispersion paste (iii) (29.4 parts) was added to 312.5 parts of the 32% aqueous carboxy-containing acrylic-modified epoxy resin dispersion (A-1) obtained in Production Example 3. The resulting mixture was then stirred well to give a black aqueous coating composition with a solids content of about 32.7%.

### Comparative Example 2 Production of Aqueous Heat-Resistant Coating Composition

One hundred parts of ethylene glycol monobutyl ether and 30 parts of N,N-dimethylaminoethanol were added to 250 parts of the 40% carboxy-containing acrylic resin (b-1) obtained in Production Example 2 to give a solution, followed by gradually adding 200 parts of deionized water to give an aqueous dispersion. Excess solvent was distilled off under reduced pressure to give an aqueous acrylic resin dispersion with a solids content of 35%. Seventy-five parts of the 60% pigment dispersion paste (i) obtained in Example 1 was added to 288 parts of this aqueous dispersion, and the resulting mixture was stirred well to give a black aqueous heat-resistant coating composition with a solids content of 40.2%.

### Comparative Example 3 Production of Aqueous Heat-Resistant Coating Composition

Seventy-five parts of the 60% pigment dispersion paste (i) obtained in Example 1 was added to a silicone emulsion (trade name “X-52-1435”, product of Shin-Etsu Chemical Co., Ltd., having a solids content of 52%). Further, 44 parts of ethyelene glycol monobutyl ether and 70 parts of deionized water were added, and the resulting mixture was stirred to give a black aqueous heat-resistant coating composition with a solids content of about 38%.

Preparation of Test Plates

Each of the aqueous heat-resistant coating compositions obtained in Examples 1 to 4 and Comparative Examples 1 to 3 was applied by spray coating to a cold rolled steel sheet (70×150×0.8 mm) degreased with methyl ethyl ketone to a thickness of 20 to 25 μm, and dried using a hot air circulating dryer at 140° C. for 5 minutes to prepare coated test plates, except that in the case of the composition of Comparative Example 3, drying was performed at 150° C. for 30 minutes.

Performance Tests

The coated test plates thus obtained were subjected to coating performance tests to evaluate their coating state, adhesion, corrosion resistance, and coating hardness. After a heat resistance test was performed by placing the test plates in an electric furnace set at 500° C. to maintain the coated substrates in a temperature range of 420 to 450° C. for 30 seconds and then allowing to cool to room temperature, coating performance tests were performed to evaluate their coating state, adhesion, and corrosion resistance. The coating performance tests were performed according to the following methods:

Coating state: the coated surface of the coated test plate was observed by the naked eye, and evaluated according to the following criteria.

A: There was no abnormality in appearance.

B: Blistering, discoloration, or cracking was observed on a portion of the coated surface.

C: Cracking occurred over the entire surface and coating peeling was observed.

Adhesion: The coating film of the coated test plate was cut crosswise with a cutter knife to reach the substrate to give a grid of one hundred 1 mm×1 mm squares. An adhesive tape was applied to the surface of the gridded portion and quickly peeled off, and the number of squares on which the coating remained was counted. The greater the number of squares, the better is the adhesion of the coating film.

Corrosion resistance: The coated test plate was tested for the degree of rust occurrence after 72 hours according to a salt spray test (JIS-Z-2371) and evaluated according to the following criteria.
A: No rusting was observed.
B: Rusting occurred on 20% or less of the entire surface area.
C: Rusting occurred on more than 20% but less than 50% of the entire surface area.
D: Rusting occurred on at least 50% of the entire surface area.

Coating hardness: The coating film of the coated test plate was subjected to a pencil scratch test according to JIS K-5600-5-4 to determine its pencil hardness.

Table 1 shows the results.

TABLE 1

| | | | | | | Comparative | | |
|---|---|---|---|---|---|---|---|---|
| | | Example | | | | Example | | |
| | | 1 | 2 | 3 | 4 | 1 | 2 | 3 |
| Initial | Coating state | A | A | A | A | A | A | A |
| | Adhesion | 100 | 100 | 100 | 100 | 100 | 100 | 84 |
| | Corrosion | A | A | A | B | C | D | C |
| | resistance | | | | | | | |
| | Hardness | 3H | 3H | 3H | 3H | 3H | F | HB |
| After heat | Coating state | A | A | A | A | A | C | A |
| resistance | Adhesion | 100 | 100 | 100 | 100 | 100 | 0 | 20 |
| test | Corrosion | B | B | B | B | D | D | D |
| | resistance | | | | | | | |

### Example 5 Production of Aqueous Heat-Resistant Coating Composition and Preparation of Coated Test Plate

Fifteen parts of electrolytic manganese dioxide and 20 parts of an aluminum dihydrogen tripolyphosphate rust-preventive pigment (trade name “K-WHITE 450H”, product of Tayca Corporation) were added to 23.3 parts of ethylene glycol monobutyl ether, and the resulting mixture was dispersed using a sand mill to a particle size of not more than 20 μm, thus giving a pigment dispersion paste (iv) with a pigment content of 60%.

The pigment dispersion paste (iv) was added to 296.9 parts (95 parts on a solids basis) of the 32% aqueous carboxy-containing acrylic-modified epoxy resin dispersion (A-1) obtained in Production Example 3, and 5 parts, on a solids basis, of a resol phenolic resin (trade name “Shonol CKS-3865”, product of Showa Highpolymer Co., Ltd., having a number average molecular weight of about 1,000 and an average of about 1.0 methylol group per benzene nucleus) to form a mixture comprising 15 parts of electrolytic manganese dioxide and 20 parts of “K-WHITE450H”. Deionized water and ethylene glycol monobutyl ether were added thereto and mixed to give a black aqueous heat-resistant coating composition with a solids content of 35%.

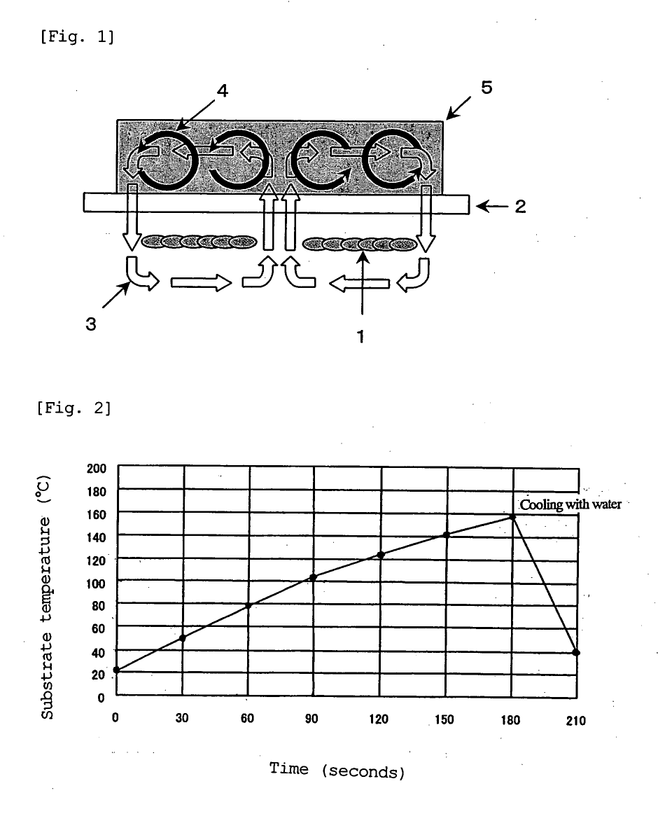

The heat-resistant coating composition was applied by spray coating to a 10 mm-thick flat cast iron plate (70×150 mm) substrate to a thickness of 20 μm, and allowed to stand at room temperature for 2 minutes. The coated substrate was then placed on the plate of an electromagnetic-induction heater as shown in FIG. 1, and heated for 3 minutes while controlling the current running through the magnetic field generation coil at 750 W. Immediately after the heating, the coated substrate was cooled with water to prepare a coated test plate. The maximum substrate temperature achieved by heating was 158° C. FIG. 2 is a graph of substrate temperature with time during the preparation of the coated test plate.

### Example 6 Production of Aqueous Heat-Resistant Coating Composition and Preparation of Coated Test Plate

Ten parts of graphite, 15 parts of “K-WHITE 450H”, and 30 parts of alumina powder (trade name “AM-21”, product of Sumitomo Chemical Co., Ltd., extender pigment) were mixed with 36.7 parts of ethylene glycol monobutyl ether, and the resulting mixture was dispersed using a sand mill to a particle size of 20 μm or less, thus giving a pigment dispersion paste (v) with a pigment content of 60%.

The pigment dispersion paste (v) was added to 281.3 parts (90 parts on a solids basis) of the 32% aqueous carboxy-containing acrylic-modified epoxy resin dispersion (A-1) obtained in Production Example 3 and 10 parts, on a solids basis, of a resol phenolic resin (trade name “Shonol CKS-3865”, product of Showa Highpolymer Co., Ltd.) to form a mixture comprising 10 parts of graphite and 15 parts of “K-WHITE450H”. Deionized water and ethylene glycol monobutyl ether were added thereto and mixed to give a black aqueous heat-resistant coating composition with a solids content of 40%.

A coated test plate was prepared in the same manner as in Example 5 except that the above heat-resistant coating composition was used.

### Example 7 Production of Aqueous Heat-Resistant Coating Composition and Preparation of Coated Test Plate

Ten parts of electrolytic manganese dioxide and 15 parts of “K-WHITE 450H” were mixed with 16.7 parts of ethylene glycol monobutyl ether, and the resulting mixture was dispersed using a sand mill to a particle size of not more than 20 μm, thus giving a pigment dispersion paste (vi) with a pigment content of 60%.

The pigment dispersion paste (vi) was added to 296.9 parts (95 parts on a solids basis) of the 32% aqueous carboxy-containing acrylic-modified epoxy resin dispersion (A-1) obtained in Production Example 3 and 5 parts, on a solids basis, of a resol phenolic resin (trade name “Shonol CKS-3865”, product of Showa Highpolymer Co., Ltd.) to form a mixture comprising 10 parts of electrolytic manganese dioxide and 15 parts of “K-WHITE450H”. Deionized water and ethylene glycol monobutyl ether were added thereto and mixed to give a black aqueous heat-resistant coating composition with a solids content of 35%.

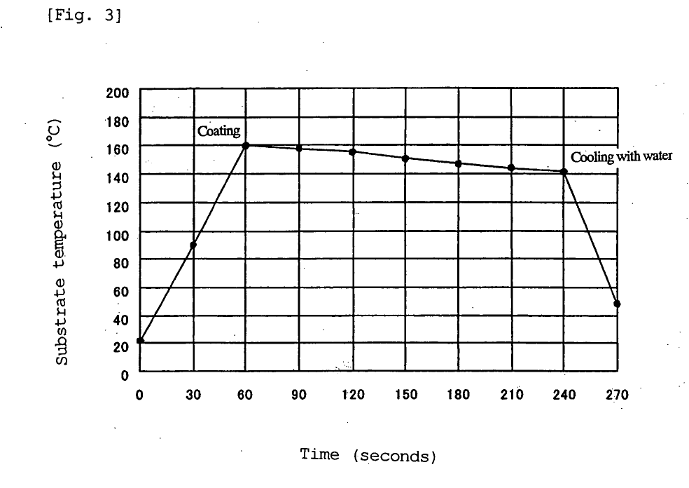

A 10 mm-thick flat cast iron plate (70×150 mm) substrate was placed on the plate of an electromagnetic-induction heater as shown in FIG. 1, and heated to a substrate temperature of 160° C. while controlling the current running through the magnetic field generation coil at 1,000 W. After the current was turned off, the heat-resistant coating composition was applied by spray coating to a thickness of 20 μm and allowed to stand for 3 minutes to cool. Immediately after the cooling, the coated substrate was quickly cooled by showering with water to prepare a coated test plate. During the 3 minutes of the cooling, the substrate temperature remained within the range of 160 to 142° C. FIG. 3 is a graph of substrate temperature with time during the preparation of the coated test plate.

### Example 8

A coated test plate was prepared in the same manner as in Example 7 except for using the black aqueous heat-resistant coating composition with a solids content of 40% obtained in Example 6.

Performance Tests

The coated test plates obtained in Examples 5 to 8 were subjected to coating performance tests to evaluate their coating state, adhesion, corrosion resistance, and coating hardness according to the above test methods. After a heat resistance test was performed by placing the test plates in an electric furnace set at 500° C. to maintain the coated substrates at a temperature of 420 to 450° C. for 30 seconds and then allowing to cool to room temperature, coating performance tests were performed to evaluate their coating state, adhesion, and corrosion resistance.

Table 2 shows the results.

TABLE 2

Example

| | | 5 | 6 | 7 | 8 |
|---|---|---|---|---|---|
| Initial | Coating state | A | A | A | A |
| | Adhesion | 100 | 100 | 100 | 100 |
| | Corrosion | A | A | A | A |
| | resistance | | | | |
| | Hardness | 3H | 3H | 3H | 3H |
| After heat | Coating state | A | A | A | A |
| resistance | Adhesion | 100 | 100 | 100 | 100 |
| test | Corrosion | B | B | B | B |
| | resistance | | | | |

1. An aqueous heat-resistant coating composition comprising:
(A) an aqueous carboxy-containing acrylic-modified epoxy resin dispersion obtained by neutralizing a carboxy-containing acrylic-modified epoxy resin with a basic compound and dispersing the neutralized resin in an aqueous medium;
(B) an inorganic coloring pigment; and
(C) a rust-preventive pigment.

2. The aqueous heat-resistant coating composition according to claim 1 wherein the carboxy-containing acrylic-modified epoxy resin is obtained by esterifying (a) a bisphenol epoxy resin and (b) a carboxy-containing acrylic resin.

3. The aqueous heat-resistant coating composition according to claim 1 wherein the carboxy-containing acrylic-modified epoxy resin is obtained by graft polymerizing onto (a) a bisphenol epoxy resin a monomer mixture comprising a carboxy-containing polymerizable unsaturated monomer.

4. The aqueous heat-resistant coating composition according to claim 1 wherein the inorganic coloring pigment (B) is manganese dioxide.

5. The aqueous heat-resistant coating composition according to claim 1 wherein the rust-preventive pigment (C) is an aluminum dihydrogen tripolyphosphate rust-preventive pigment.

6. The aqueous heat-resistant coating composition according to claim 5 wherein the aluminum dihydrogen tripolyphosphate rust-preventive pigment has been surface-treated with magnesium oxide or zinc oxide.

7. The aqueous heat-resistant coating composition according to claim 1 wherein the total amount of inorganic coloring pigment (B) and rust-preventive pigment (C) is 5 to 100 parts by weight per 100 parts by weight of aqueous carboxy-containing acrylic-modified epoxy resin dispersion (A), on a solids basis.

8. The aqueous heat-resistant coating composition according to claim 1 which further comprises (D) a resol phenolic resin.

9. The aqueous heat-resistant coating composition according to claim 8 wherein the resol phenolic resin (D) has a number average molecular weight of 200 to 2,000 and an average of 0.3 to 4.0 methylol groups per benzene nucleus.

10. The aqueous heat-resistant coating composition according to claim 8 wherein the amount of resol phenolic resin (D) is 0.1 to 30 parts by weight per 100 parts by weight of aqueous carboxy-containing acrylic-modified epoxy resin dispersion (A), on a solids basis.

11. An application process comprising applying the aqueous heat-resistant coating composition of claim 1 to a metal substrate and then heat-drying to form a heat-resistant dried coating film.

12. The process according to claim 11 wherein the heat-drying is performed by electromagnetic induction heating.

13. The process according to claim 11 wherein the metal substrate is a disc break part.

14. An application process comprising heating a metal substrate by electromagnetic induction and then applying the aqueous heat-resistant coating composition of claim 1 to the substrate, followed by allowing the residual heat to dry the composition to form a heat-resistant dried coating film.

15. The process according to claim 14 wherein the metal substrate is a disc break part.

16. A coated article comprising a heat-resistant dried coating film formed on a metal substrate by the process of claim 11.

17. The coated article according to claim 16 wherein the metal substrate is a disc break part.

18. A coated article comprising a heat-resistant dried coating film formed on a metal substrate by the process of claim 14.

19. The coated article according to claim 18 wherein the metal substrate is a disc break part.
